(19) United States
(12) Patent Application Publication
(10) Pub. No.: US 2006/0072300 A1
(43) Pub. Date: Apr. 6, 2006

(54) Illumination device

(75) Inventor: Yukiharu Hayashi, Miyagi-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/235,013

(22) Filed: Sep. 23, 2005

(30) Foreign Application Priority Data
Oct. 5, 2004 (JP) 2004-292615

(51) Int. Cl. G01D 11/28

(52) U.S. Cl. 362/29; 362/95

(57) ABSTRACT

An illumination device includes a circuit board, a light source mounted to the circuit board, a push knob having a text display unit and an arrow display unit which are illuminated from the rear sides by illuminating rays emitted from the light source, a light leakage preventing ring mounted to the push knob, a light intensity distribution adjusting member disposed between the light source and the push knob, and a resin holder serving as a reflector. A lower end of the resin holder serving as a reflector is mounted on the circuit board, and the push knob is mounted on an upper end of the resin holder. The light intensity distribution adjusting member has a semitransparent diffusion reflective portion formed in a center area and a transparent portion formed in a peripheral area.

### BACKGROUND OF THE INVENTION

1. Field of the Invention

The present invention relates to an illumination device which is provided in a switch knob or the like, and more particularly, to a light intensity distribution adjusting member for making light intensity distribution of illuminating rays irradiated onto a display unit uniform.

2. Description of the Related Art

Generally, an illumination device for illuminating a display unit included in a switch knob or the like is provided in a switch apparatus for a vehicle, in order to easily and reliably operate the switch knob even at night or in dark places.

FIG. 4 is a cross-sectional view showing a switch apparatus for a vehicle which has this kind of a generally known illumination device. As apprehended from FIG. 4, the switch apparatus for a vehicle includes a printed board 101, a plurality of LEDs (light-emitting diodes) 102 mounted on the printed board 101, a tact switch 103, a display unit 106 which is fixed on the printed board 101 with a bracket 104 interposed therebetween and is electrically connected to the printed board through a leading line 105, a diffusion plate 107 which is a light intensity distribution adjusting member interposed between the tact switch 103 and the display unit 106, a rotary dial knob 109 having a light-transmitting window member 108, and a rotary encoder 110 composed of a fixed member 110a fixed on the printed board 101, a rotation member 101b connected to the rotary dial knob 109, and light emitting/receiving elements (not shown) (for example, JP-A-2003-54290).

Since the illumination device provided in the switch device for a vehicle has the diffusion plate 107 provided between the LEDs 102 that is a light source for illumination and the display unit 106, the illuminating rays emitted from the LEDs 102 can be diffused by the diffusion plate 107, thus the intensity of the illuminating rays irradiated onto the display unit 106 can be made uniform, as compared with the case in which the illuminating rays emitted from the LEDs 102 are directly irradiated onto the display unit 106.

However, in the illumination device according to the related art, since the light intensity distribution adjusting member is constructed to have the homogeneous diffusion plate 107, high-intensity center light and low-intensity peripheral light to be emitted from the LEDs 102 are diffused at a substantially uniform ratio, thus there was a problem in that it is hard to decrease irregular illumination to a level that is practically required, as schematically shown in FIG. 5. Such a problem becomes more obvious as the number of light sources to be mounted on the printed board decreases.

### SUMMARY OF THE INVENTION

The present invention has been finalized in view of the drawbacks inherent in the illumination device according to the related art, and it is an object of the present invention to provide an illumination device which can illuminate uniformly over a wide range of area without irregular illumination even when a light source having high directivity is exclusively set in the center.

In order to solve the above-described problem, according to an aspect of the invention, an illumination device includes a light source disposed in a center portion, a display unit which is illuminated from a rear side by illuminating rays emitted from the light source, a light intensity distribution adjusting member which is disposed between the light source and the display unit. In addition, the light intensity distribution adjusting member has a semitransparent diffusion reflective portion formed in a center area and a transparent portion formed in a peripheral area.

In this way, the illumination device uses the light intensity distribution adjusting member having the semitransparent diffusion reflective portion formed in the center area thereof and the transparent portion formed in the peripheral area. Therefore, even when a light source such as an LED having high directivity is used, the light intensity of illuminating rays of high-intensity center light transmitted through the light intensity distribution adjusting member can be reduced by the semitransparent diffusion reflective portion, on the other hand, low-intensity peripheral light can be transmitted through the transparent portion without decreasing light intensity. Accordingly, the light intensity of illuminating rays irradiated onto the display unit can be made uniform.

In addition, in the illumination device, a reflector is disposed at the light source side of the light intensity distribution adjusting member, the reflector reflecting a portion of illuminating rays reflected by the light intensity distribution adjusting member toward the light intensity distribution adjusting member.

Since a semitransparent diffusion reflective portion is provided in the light intensity distribution adjusting member, a portion of illuminating rays emitted from the light source is reflected by the semitransparent diffusion reflective portion, thereby not being transmitted through the light intensity adjusting member. Therefore, when a portion of illuminating rays which have been reflected by the semitransparent diffusion reflective portion is re-reflected by the reflector toward the light intensity distribution adjusting member, inefficiency of the illuminating rays can be prevented, and irregular illumination can be further alleviated.

In addition, in the illumination device, the reflector has a conical reflective surface and an inlet for the illuminating rays, the inlet being formed at the top of the reflective surface.

In this way, the reflective surface of the reflector is formed in a conical shape, and the inlet for the illuminating rays is formed at the top of the reflective surface. Therefore, the illuminating rays which has been reflected by the semitransparent diffusion reflective portion and reached the reflective surface of the reflector can head toward areas within the range set by the light intensity distribution adjusting member, thus making the use of the illuminating rays more efficient and making the light intensity of the illuminating rays irradiated onto the display unit more uniform.

In the illumination device, the reflector is formed with one surface of a resin holder for holding the light intensity distribution adjusting member.

According to the structure, since the reflector and the resin holder can be integrally formed, the number of components and assembly processes can be reduced, and thus low cost of the illumination device can be achieved.

Further, in the illumination device, the entire resin holder including the reflector is molded of a white resin.

According to the structure, since a reflective surface having high reflectance can be formed without forming a special reflective member in the resin holder, it is possible to eliminate the irregular illumination of the display unit with a simple structure.

Further, in the illumination device, a support portion is integrally formed at the rear side of the resin holder, the support portion mounting the resin holder on a circuit board on which the light source is mounted.

According to the structure, since the reflector, the resin holder, and support members can be integrally formed, the number of components and assembly processes can be reduced, and thus low cost of an illumination device can be achieved.

### BRIEF DESCRIPTION OF THE DRAWINGS

FIG. 1 is an exploded perspective view of an illumination device according to an embodiment of the invention;

FIG. 2 is a cross-sectional view of essential elements of a switch apparatus having the illumination device according to the embodiment of the invention;

FIG. 3 is an explanatory view schematically showing the effects of the illumination device according to the embodiment of the invention;

FIG. 4 is a cross-sectional view of a switch apparatus for a vehicle which has an illumination device according to the related art; and

FIG. 5 is an explanatory view schematically showing disadvantages of the illumination device according to the related art.

### DESCRIPTION OF THE PREFERRED EMBODIMENT

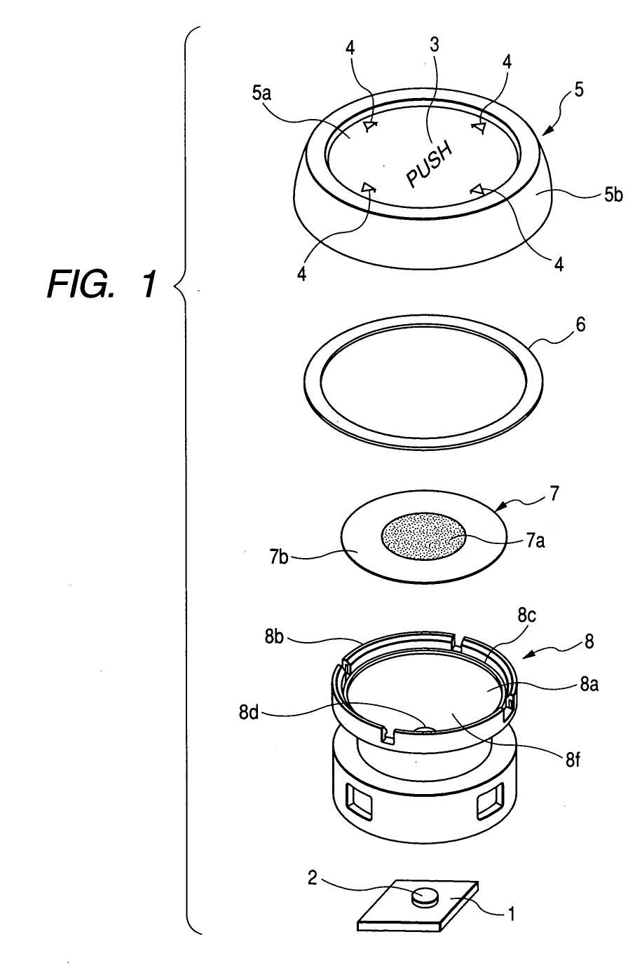

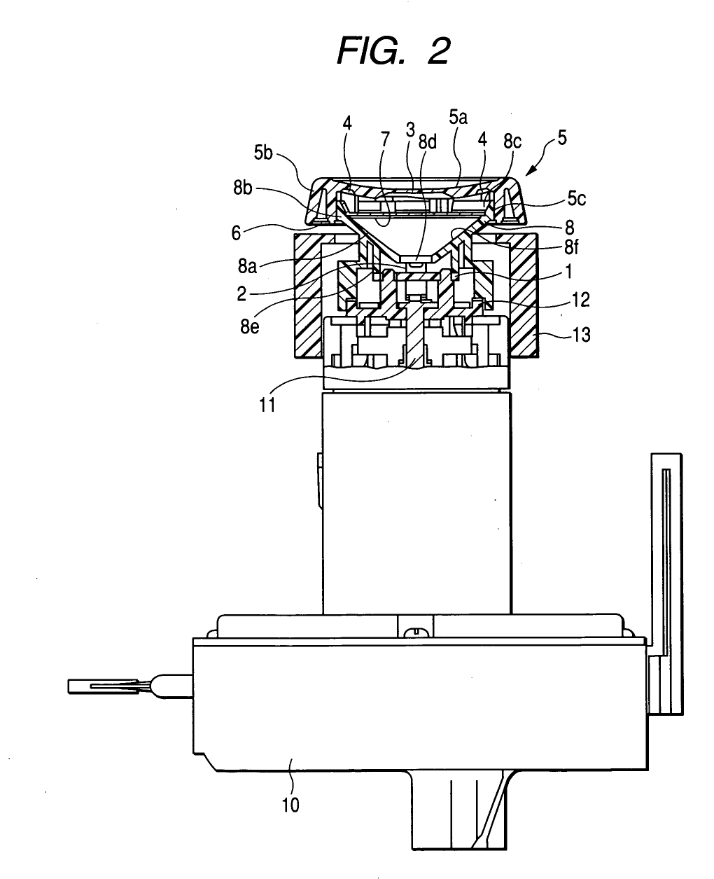

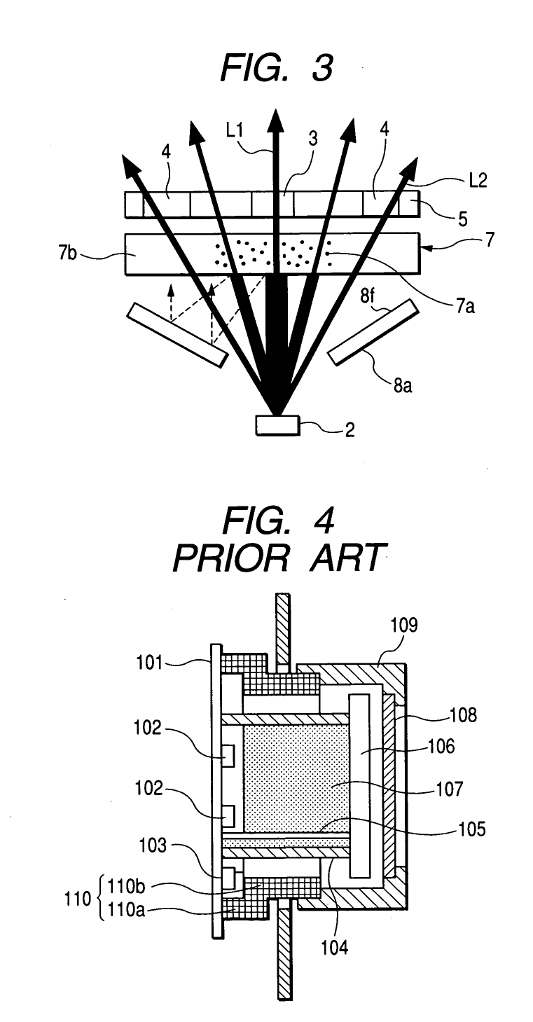

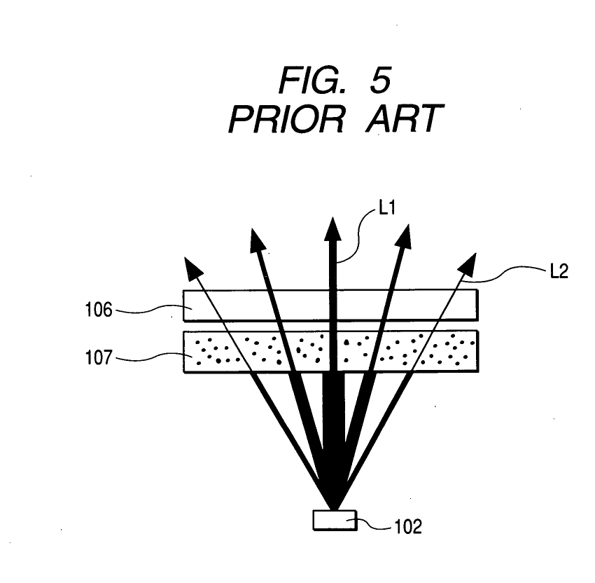

Hereinafter, with an illumination device provided in a switch apparatus taken as an example, an illumination device according to an embodiment of the invention will be described with reference to FIGS. 1 to 3. FIG. 1 is an exploded perspective view of the illumination device according to the embodiment. FIG. 2 is a cross-sectional view of essential elements of the switch apparatus having the illumination device according to the embodiment. FIG. 3 is an explanatory view schematically showing the effects of the illumination device according to the embodiment.

As shown in FIGS. 1 and 2, the illumination device according to the embodiment is provided with a circuit board 1; a light source 2 mounted on the circuit board 1; a push knob 5 having a text display unit 3 and arrow display units 4; a light leakage preventing ring 6 attached to the push knob 5; a light intensity distribution adjusting member 7 disposed between the light source 2 and the push knob 5; and a resin holder 8 serving as a reflector. The text display unit 3 and the arrow display units 4 are illuminated from the rear sides thereof by illuminating rays emitted from the light source 2. The resin holder 8 serving as a reflector has its upper end on which the push knob 5 and the light intensity distribution adjusting member 7 are mounted and its lower end fixed on the circuit board 1.

In FIG. 2, a reference numeral 10 indicates a main body of the switch apparatus in which the illumination device according to the embodiment is provided. A reference numeral 11 indicates a switch operating shaft set in the main body 10. A reference numeral 12 indicates a board mounting member which is fixed at an upper end of the switch operating shaft 11. A reference numeral 13 indicates a rotary knob which is rotatably set around the main body 10. The switch operating shaft 11 can be pushed in a vertical direction, and can be tilted in four directions orthogonal to each other.

As the light source 2, any known light-emitting body can be used, however, an LED is preferably used because its small size guarantees a long life span.

The push knob 5 has a resin molding and is formed in a cap shape including a top plate 5a, a ring-shaped grip portion 5b, and a connection portion 5c. The push knob 5 further includes a thin-walled portion formed at a predetermined location of a center portion and a peripheral portion of the top plate 5a, and the light-transmitting text display unit 3 and the light-transmitting arrow display units 4 are provided therein. Further, as shown in FIG. 1, the text display unit 3 is formed at the center portion of the top plate 5a, and the arrow display units 4 are formed at four places of the peripheral portion of the top plate 5a at a pitch of 90 degrees.

The light leakage preventing ring 6 is made of a light-shielding material in a ring shape. The light leakage preventing ring 6 is adhered between a front end of the grip portion 5b and a front end of the connection portion 5c. Accordingly, unnecessary light leakage from the push knob 5 is prevented.

The light intensity distribution adjusting member 7 is formed of a light-transmitting material in a ring shape, a center area of the light intensity distribution adjusting member 7 becomes a semitransparent diffusion reflective portion 7a, and a peripheral area thereof becomes a transparent portion 7b. The diameter of the semitransparent diffusion reflective portion 7a is determined after taking radiation characteristics of the light source 2 and the distance from the light source 2 to the light intensity distribution adjusting member 7 into account.

The resin holder 8 serving as a reflector has a white resin molding. The resin holder 8 is formed by integrating a conical portion 8a, a ring-shaped push knob mounting portion 8b which is erected vertically from an upper end of the conical portion 8a, a light intensity distribution adjusting member setting step portion 8c formed at an inner periphery of the push knob mounting portion 8b, an inlet 8d for illuminating rays formed at the top of the conical portion 8a, and a ring-shaped support portion 8e provided vertically from the bottom surface of the conical portion 8a. In this way, since the resin holder 8 serving as a reflector is formed by integrating the above-described members 8a to 8e, the number of components and assembly processes can be reduced, and thus the low cost of an illumination device can be achieved. Further, since the resin holder 8 serving as a reflector according to the embodiment is constructed by using the white resin molding, a special reflective member does not need to be provided in the resin holder 8 serving as a reflector. In other words, it is possible to eliminate the irregular illumination of the text display unit 3 and the arrow display unit 4 with a simple structure.

An inner surface 8f of the conical portion 8a is smoothly formed, and becomes a reflective surface of the resin holder 8 serving as a reflector. The inclined angle of the reflective surface 8f is set such that the returning light from the light intensity distribution adjusting member 7 reflected by the reflective surface 8f is reflected again within the range set by the light intensity distribution adjusting member 7.

The outer diameter of the push knob mounting portion 8b is formed with such a diameter that the push knob mounting portion 8b can be tightly fit in the ring-shaped connection portion 5c formed in the push knob 5. Further, the inner diameter of the light intensity distribution adjusting member setting step portion 8c is formed with such a diameter that the light intensity distribution adjusting member 7 can be tightly fit in the light intensity distribution adjusting member setting step portion 8c. In addition, the support portion 8e is formed such that the support portion 8e can be fit in the circuit board 1 so as to be mounted thereon.

Hereinafter, a method of assembling the illumination device according to the embodiment will be described.

First, the resin holder 8 serving as a reflector is fixed to the circuit board 1. The fixation of the resin holder 8 serving as a reflector to the circuit board 1 is implemented by having the inner periphery of the support portion 8e formed in the resin holder 8 serving as a reflector fitted into the circuit board 1.

Next, the push knob 5 is fixed to the resin holder 8 serving as a reflector. The fixation of the push knob 5 to the resin holder 8 serving as a reflector is implemented by having the ring-shaped push knob mounting portion 8b formed in the resin holder 8 serving as a reflector fitted into the inner periphery of the ring-shaped connection portion 5c formed in the push knob 5.

Finally, the circuit board 1 having the light source 2 mounted therein is mounted on the board mounting member 12 fixed on an upper end of the switch operating shaft 11. The fixation of the circuit board 1 on the board mounting member 12 is implemented by having a pin 12a with a small diameter formed in the upper end of the board mounting member 12 fitted into a through-hole 1a formed in the circuit board 1 (see FIG. 2).

The illumination device according to the embodiment constructed as described above uses one having the semitransparent diffusion reflective portion 7a formed in the center area and the transparent portion 7b formed in the peripheral area as the light intensity distribution adjusting member 7. Thus, as shown in FIG. 3, even though a light source such as an LED having high directivity is used, the light intensity of illuminating rays of high-intensity center light L1 transmitted through the light intensity distribution adjusting member 7 can be reduced by the semitransparent diffusion reflective portion 7a, on the other hand, low-intensity peripheral light L2 can be transmitted through the transparent portion 7b without decreasing light intensity. Therefore, the light intensity of illuminating rays irradiated onto the text display unit 3 and the arrow display units 4 can be made uniform and irregular illumination can be eliminated. In addition, in the illumination device according to the embodiment, the reflective surface 8f is disposed between the light source 2 and the light intensity distribution adjusting member 7, and the reflective surface 8f reflects a portion of illuminating rays reflected by the light intensity distribution adjusting member 7 toward the light intensity distribution adjusting member 7. Thus, the illuminating rays can be used efficiently, and the light intensity of the illuminating rays irradiated onto the text display unit 3 and the arrow display units 4 can be made further uniform. In addition, in the illumination device according to the embodiment, the reflective surface 8f is formed in a conical shape, and the inlet 8d for the illuminating rays is formed at the top of the reflective surface 8f. Therefore, the illuminating rays which have been reflected by the semitransparent diffusion reflective portion 7 and reached the reflective surface 8f can head toward areas within the range set by the light intensity distribution adjusting member 7, thus making the use of the illuminating rays more efficient.

Further, in the above-described embodiment, the thin-walled portion formed in the top plate 5a is provided and the light-transmitting text display unit 3 and arrow display units 4 are formed therein. On the other hand, the push knob 5 excluding the text display unit 3 and the arrow display units 4 is molded of a light-shielding resin and the text display unit 3 and the arrow display units 4 are molded of a light-transmitting resin. As a result, the light-transmitting text display unit 3 and the arrow display units 4 can be formed in the top plate 5a.

In addition, although the resin holder 8 serving as a reflector is used in the above-described embodiment, a resin holder integrated with a reflector can be used. In this case, two colors can be given each for the light-transmitting resin and the reflective resin, and the reflector made of metal materials and the resin holder can be integrally molded by methods such as an outsert molding.

The illumination device of the invention uses the light intensity distribution adjusting member having the semitransparent diffusion reflective portion formed in the center area and the transparent portion formed in the peripheral area. Thus, even though a light source such as an LED having high directivity is used, the light intensity of illuminating rays irradiated onto the display unit can be made uniform and irregular illumination of the display unit can be eliminated.

1. An illumination device that includes a light source disposed in a center portion, a display unit which is illuminated from a rear side by illuminating rays emitted from the light source, and a light intensity distribution adjusting member disposed between the light source and the display unit,
wherein the light intensity distribution adjusting member has a semitransparent diffusion reflective portion formed in a center area and a transparent portion formed in a peripheral area.

2. The illumination device according to claim 1,
wherein a reflector is disposed at the light source side of the light intensity distribution adjusting member, the reflector reflecting a portion of illuminating rays reflected by the light intensity distribution adjusting member toward the light intensity distribution adjusting member.

3. The illumination device according to claim 2,
wherein the reflector has a conical reflective surface and an inlet for the illuminating rays, the inlet being formed at the top of the reflective surface.

4. The illumination device according to claim 2,
wherein the reflector is formed with one surface of a resin holder for holding the light intensity distribution adjusting member.

5. The illumination device according to claim 2,
wherein the entire resin holder including the reflector is molded of a white resin.

6. The illumination device according to claim 4,
wherein a support portion is integrally formed at a rear side of the resin holder, the support portion mounting the resin holder on a circuit board on which the light source is mounted.
